(19) United States
(12) Patent Application Publication
(10) Pub. No.: US 2008/0107867 A1
(43) Pub. Date: May 8, 2008

(54) Thermally Conductive Low Profile Bonding Surfaces

(76) Inventor: Fred Miekka, Arcadia, CA (US)

Correspondence Address: DENIS KHOO, 9729 CAMINO REAL, ARCADIA, CA, 91007, US

(21) Appl. No.: 11/935,352

(22) Filed: Nov. 5, 2007

Related U.S. Application Data
(60) Provisional application No. 60/856,971, filed on Nov. 6, 2006.
(60) Provisional application No. 60/897,325, filed on Jan. 25, 2007.

(51) Int. Cl. B32B 3/00

(52) U.S. Cl. 428/141

(57) ABSTRACT

Low profile circuit boards having heat dissipative properties are disclosed having numerous discrete heat dissipating bonding zones. These electric circuit boards help dissipate heat from individual components such as transistors. Thermally conductive protrusions that may have an ultra low profile may be employed to promote bonding and remove heat. The resulting circuit boards are compact and have good heat dissipating properties. The ultra low profile protrusions disclosed in the present invention may also be used in other applications as well.

This application claims the benefit of and priority of U.S. Provisional Patent Application Ser. No. 60/856,971, entitled “Heat Dissipating Circuit Bonding Construction” by Fred Miekka, filed on Nov. 6, 2006 and U.S. Provisional Patent Application Ser. No. 60/897,325, entitled “Low Profile Interlocking Bonding Construction” by Fred Miekka, filed on Jan. 25, 2007.

### BACKGROUND OF THE INVENTION

1. Field of the Invention

This invention relates to low profile bonding two surfaces that may have thermal conductivity, electrical conductivity, or magnetic permeability together with minimal losses occurring across the resultant bonding zone. More particularly this invention relates to low profile bonding in electrical circuit boards employing surface mount technology to heat producing electrical components.

2. Description of the Related Art

Thermal conductivity is a property common to many materials and especially metals. A thermally conductive material is a substance that allows the rapid flow of heat throughout its mass. Many electrical components such as resistors and semi-conductor devices generate considerable amounts of heat during their operation. This heat may result from electrical losses from voltage drops across current carrying conductors. More particularly, power dissipation in watts is equal to the voltage drop across the device times the current flowing through the device in amperes. Voltage drops may take numerous forms including the following:

1) V=IR in resistors where V=The voltage drop across the device, I=The current in amperes flowing through the device, and R=The resistance value in Ohms.

2) Semi-conductor junction potentials. Semi-conductor devices such as diodes have a voltage drop associated with them that is dependent on the particular device. This forward voltage drop typically varies from 0.4 volts to 1.0 volts.

3) Electrical losses in transistor devices such as MOSFETS. Transistors are semi-conductor devices that amplify signals by allowing a small input current to control a much larger output current. MOSFETS are a special type of transistor known as metal oxide semi-conductor field effect transistors. MOSFETS have very high amplification values and can be used as solid state switches for direct current as well as voltage controlled amplifiers. MOSFETS have the following characteristics with respect to voltage drops. They have a specified on state resistance expressed in Ohms and switching losses.

3a) On state resistance refers to the resistance of the device in Ohms to direct current flowing through the device at a specified level when the device is fully switched on. This on state resistance rating is usually specified at a relatively low operating temperature. Generally speaking, as operating temperatures increase so do the on state resistance values of MOSFETS.

3b) Switching losses refer to heat generating electrical losses associated with voltage drops that occur as a result of the device being only partially turned on or partially turned off. When a mosfet or other semi-conductor transistor device is being turned on, a significant voltage drop may occur across the device prior to the device being fully turned on. Likewise, the same situation holds true when switching such devices off. It takes time to turn on and to turn off transistors. During this switching interval The transistor behaves like a resistor and may exhibit appreciable voltage drops. These voltage drops result in switching losses that show up in the form of heat.

3c) Semi-conductor junction losses may also be present in transistors owing to the presence of junctions.

4) Resistive losses in coils and other current carrying devices.

5) Capacitive heating effects in devices involved in high frequency switching.

5a) Sometimes referred to as dielectric loss.

6) Inductive heating effects

6a) Eddy currents induced in conductive materials in the presence of changing magnetic fields.

Many of the elements in the periodic table are metals. Metallic elements such as copper, aluminum, and silver are good conductors of heat and electricity. Because of this they are used in electrical circuitry to carry electric current as well as heat sinks for removal of heat from heat generating components. Of all of the metallic elements, silver and copper are the best conductors of both heat and electricity. Because of the higher cost of silver, copper is commonly employed for this purpose. Aluminum and many of its alloys are also good conductors of heat and electricity. Aluminum is lower in cost than both copper and silver. Unlike copper, aluminum has a strong tendency to form electrically insulating oxide coatings on exposure to air. Because of this, aluminum may not be suitable for many applications requiring the conduction of electric current across two or more contacting surfaces. In addition, aluminum and its associated alloys often present significant difficulties in the soldering process. When ordinary tin lead alloy solder is melted against an aluminum surface, proper flow and surface wet out may not occur. This may be particularly true for use in printed circuit boards where components are soldered into place.

Printed circuits are comprised of numerous electrical components that are soldered into place and electrically connected to each other onto a printed circuit board. The printed circuit board itself often takes the form of a flat planar rigid electrically insulating construction having electrically conductive copper clad laminated on to one or both sides. Copper is often used because it is a good conductor of electricity and lower in cost than silver. Unlike aluminum that is hard to solder to, copper readily accepts melted solder thereby providing good wet out properties.

Traditional printed circuits are made in the following manner. One or more exposed copper surfaces of a printed circuit board is covered with a thin layer of photo resist. Photo resist is a material that changes its solubility to certain developing solutions on exposure to light. Negative photo resists become less soluble on light exposure while positive resists become more soluble on light exposure. A pattern of conductive paths required for the particular circuit in question is made on a transparent plastic film using photographic techniques. This film with its pattern may be referred to as a master. The master is placed over the copper clad board and exposed to light for a set period of time. This may be carried out under the conditions of vacuum in order to maintain good contact between the master and light sensitive photo resist. After exposure, the master is removed and the pattern developed in the photo resist with a suitable developing agent. The circuit board is then rinsed clean from the developing solution and the areas of exposed copper etched away with a suitable etchant. The freshly etched circuit board is then thoroughly rinsed. Photo resist that is now covering the copper pattern on the board is then removed with a stripping agent and the board rinsed clean. The result is a pattern etched board having electrically conductive paths of copper in a suitable pattern for manufacturing a printed circuit board. Holes are then drilled into the board at the appropriate locations for mounting individual electrical components. Individual components are then placed into the circuit board by placing their leads into these holes and soldered firmly into place.

It should be noted that the above described method of manufacture for printed circuit boards is a brief generalization with many possible modifications. It should also be noted that significant detail has been omitted in order to outline the overall process. Certain aspects of the process are well known art and therefore do not require significant elaboration while other aspects more relevant to the present invention will now be explained in further detail.

Etchants suitable for removing copper from developed printed circuit boards are generally water based acid solutions and often contain metal cations (positively charged metal atoms) in an oxidized state. The anions (negatively charged atoms or groups of atoms) may be any number of materials with chloride ion being common. Suitable positively charged oxidized metal atoms include ferric ions and cupric ions. Ferric ions are iron atoms having a +3 charge. Ferric ions are easily reduced to the +2 charge by the addition of one electron to become ferrous ions. Cupric ions are copper atoms having a +2 charge. Cupric ions are easily reduced to the +1 charge by the addition of one electron to become cuprous ions. These electrons come from the exposed copper metal of the board by oxidizing the copper into cuprous ion that dissolves in the acidic water based etchant. In the presence of hydrochloric acid, this cuprous ion rapidly dissolves away thereby efficiently removing unwanted copper from the board. As more and more copper dissolves into the etching solution, the etchant becomes depleted and needs to be replaced. Replacement of etchant represents both a purchasing cost for new etchant and a disposal cost from the waste depleated etchant.

Water based etchants containing cupric chloride along with hydrochloric acid may be extended by employing the following process. When cupric chloride solutions etch copper, the basic reaction can be summarized as follows:
CuCl2+Cu→2CuCl.

The resulting CuCl reacts with HCl to form chlorocuprous acid (a complex of cuprous chloride and hydrochloric acid that is water soluble). Water based solutions of chlorocuprous acid will react with hydrogen peroxide forming cupric chloride and water. The simplified overall chemical reaction can be summarized as follows:
2CuCl+2HCl+H2O2→2CuCl2+2H2O

When etching pure copper clad circuit boards with cupric chloride, it may be desirable to add a small amount of ferric chloride to the mixture. It may also be desirable to maintain and control acid levels by the addition of hydrochloric acid when needed.

It should be noted that because of water losses normally encountered in the etching process (particularly at elevated temperatures) the standard 3% hydrogen peroxide sold in ordinary drug stores will often suffice.

The above described cupric chloride etchant converts copper etched from circuit boards into more etchant. While in theory the etchant could be used forever, in practice, replacement of waste etchant and its subsequent disposal still remains an issue.

Electro-etching employs electricity as the oxidizing agent that drives the dissolving of metals. More particularly, when a positive direct current potential is placed on a piece of metal in a water based ionic solution, there is a strong tendency to oxidize the surface of the metal piece by the direct removal of electrons. Under suitable conditions the metal may be made to cleanly dissolve into the water solution.

Electro-plating employs electricity as the reducing agent that drives the deposition of metals onto conductive surfaces. More particularly, when a negative direct current potential is placed on a piece of metal in a water based solution of positively charged metal ions, there is a strong tendency to plate out metal on the surface by neutralization of metal ions with electrons. Under suitable conditions metals may be plated out in this way.

Under suitable conditions electro-etching and electro-plating may be carried out simultaneously thereby transferring metal from one surface to another. This approach may be used to alleviate a significant amount of cost associated with the purchase and disposal of etching solutions.

Electro-forming involves the patterned deposition of metals from solution onto conductive substrates. This is achieved by masking off areas where deposition is to be avoided and selectively electro-plating the exposed areas of the pattern.

Electroforming may be carried out to produce a desired pattern of raised areas or protrusions for the heat dissipating bonding applications of the present invention. In addition, electroforming operations may be carried out in order to improve heat dissipating properties of copper bonding pads by extending areas of raised surface topography beyond the bonding zone.

Heat generating circuit components present numerous issues with circuit design. Excessive heat generated within individual components has traditionally been alleviated by employing heat sinks. A heat sink is a piece of thermally conductive material that is placed against a heat generating electric circuit component to transfer heat. The heat sink itself may have ridges or other means of increasing surface area for the purposes of improving heat dissipation by the normal processes of convection, conduction, and radiation. Heat sinks are usually made of aluminum and special alloys of aluminum that conduct heat efficiently and are light weight.

Due to the method of manufacture, traditional printed circuit boards have their components in a vertical position. That is to say that when holes are drilled into a circuit board and the leads of individual components are placed into these holes and soldered into place, the components end up in a vertical position. When relatively large heat sinks are placed on these components, a significant overall vertical height often results. The high profile geometry adds significant height and bulk to finished printed circuit boards. This added height of individual components and their attached heat sinks results in a need for taller enclosures and may disrupt air flow patterns from cooling fans.

Because copper has good electric conductivity and is easy to solder to, printed circuit boards usually employ copper. It should be noted that copper is a better conductor of heat than aluminum. Because of this, the copper clad coating employed in printed circuit boards has good thermal heat dissipating properties. The thickness of this copper clad coating is typically one or two ounces of copper per square foot. Two ounce copper clad circuit boards will carry more current than the thinner one ounce per square foot copper clad boards. Because of this, higher copper thickness boards are desirable for use in high power applications. Many of these high power applications employ components that generate considerable heat during use.

Standard printed circuit board construction techniques often involve drilling numerous small holes. These holes are used for placing the leads of individual components prior to soldering into place. Drilling these holes may present problems. For example, many printed circuit boards employ glass composite materials of sufficient hardness to dull drill bits and also contain soft copper that may gum up diamond bits. Because of this, a compromise is often reached between a bit designed for hard materials and one for softer materials. Carbide bits may be employed for this purpose due to their suitable geometry for drilling into soft metals such as copper and having sufficient hardness to drill through glass laminate.

Despite numerous standard configurations for printed circuit boards there remains a need for printed circuit boards having low profile planar surface mounting means for circuit components along with good heat dissipation properties.

It is an object of this invention to provide a bonding means suitable for printed for surface mounting circuit components to circuit boards.

It is a further object of this invention to provide a bonding means having an unusually low profile.

It is a further object of this invention to eliminate component lead holes in printed circuit boards.

It is a further object of this invention to mount circuit components in a low profile configuration on printed circuit boards.

It is a further object of this invention to eliminate large and bulky heat sinks from individual components on printed circuit boards.

It is a further object of this invention to provide printed circuit boards with heat dissipating properties.

Finally it is an object of this invention to provide printed circuit boards having an overall geometry that facilitates removal of excess heat with moving air.

### SUMMARY OF THE INVENTION

This invention therefore proposes low profile bonding surfaces that may be used to surface mount heat generating electrical components to printed circuit boards. Individual circuit boards may be provided with thermally conductive mounting zones for individual circuit components along with added heat dissipation zones comprised of thermally conductive materials such as copper. Thermally conductive mounting zones may have numerous surface protrusions extending from the surface to facilitate bonding with a bonding agent. These numerous surface protrusions may have an ultra low profile that facilitates the transfer of heat from components and into heat dissipating circuit boards. Additionally, protrusions may extend beyond the bonding zone thereby providing additional heat dissipation. The printed circuit boards themselves may further employ thermally conductive materials such as copper and aluminum within their interior layers thereby turning the entire printed circuit board into one large heat sink.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 shows a standard printed circuit board employing vertically mounted components along with attached heat sinks.

FIG. 2 shows a printed circuit board employing surface mounting of components.

FIG. 3 shows a printed circuit board employing surface mount components and copper pads for heat dissipation without the need for added heat sinks.

FIG. 4 shows a printed circuit board of the present invention having a heat dissipating bonding area for attaching heat generating components with a bonding agent.

FIG. 5 shows a printed circuit board of the present invention having numerous surface protrusions extending beyond the bonding zone for improved heat dissipation.

FIG. 6 shows a printed circuit board of the present invention having a heat dissipating bonding area for attaching heat generating components with a bonding agent along with added copper fins extending beyond the bonding zone for improved heat dissipation.

FIG. 7 shows cross sectional view of a printed circuit board of the present invention having a heat dissipating bonding area for attaching heat generating components with a bonding agent along with an internal metal mesh for transferring heat throughout the entire board.

FIG. 8 shows a printed circuit board of the present invention having numerous surface protrusions extending beyond the bonding zone for improved heat dissipation along with internal metal mesh for transferring heat throughout the entire board.

FIG. 9 shows a printed circuit board of the present invention having a heat dissipating bonding area for attaching heat generating components with a bonding agent along with added copper fins extending beyond the bonding zone for improved heat dissipation and internal metal mesh for transferring heat throughout the entire board.

FIG. 10 shows cross sectional view of a printed circuit board of the present invention having a heat dissipating bonding area for attaching heat generating components with a bonding agent, internal metal mesh for transferring heat throughout the entire board, an attached heat sink, and added thermal insulation under the soldering zones.

FIG. 11 shows a thin thermally conductive metal sheet having numerous holes to promote bonding within the interior portions of a composite printed circuit board.

FIG. 12 shows a thin thermally conductive metal sheet having numerous protrusions to promote bonding within the interior portions of composite printed circuit boards.

FIG. 13 shows cross sectional view of a printed circuit board of the present invention having a heat dissipating bonding area for attaching heat generating components with a bonding agent along with internal metal sheet form for transferring heat throughout the entire board.

FIG. 14 shows a printed circuit board of the present invention having numerous surface protrusions extending beyond the bonding zone for improved heat dissipation along with internal metal sheet for transferring heat throughout the entire board.

FIG. 15 shows a printed circuit board of the present invention having a heat dissipating bonding area for attaching heat generating components with a bonding agent along with added copper fins extending beyond the bonding zone for improved heat dissipation and internal metal sheet for transferring heat throughout the entire board.

FIG. 16 shows a cross sectional view of a printed circuit board of the present invention having a heat dissipating bonding area for attaching heat generating components with a bonding agent, internal metal sheet for transferring heat throughout the entire board, an attached heat sink, and added thermal insulation under the soldering zones.

FIG. 17 shows a cross sectional view of a thermally conductive bonding pad of the present invention having numerous spherical protrusions

FIG. 18 shows a cross sectional view of a thermally conductive bonding pad of the present invention having numerous protrusions having a spherical base and flat top geometry.

FIG. 19 shows a cross sectional view of a circuit component being held into place with a magnet during the bonding agent cure cycle.

FIG. 20 shows a cross sectional view of a prior art bonding substrate having interlocking properties to bonding agents.

FIG. 21 shows a cross sectional view of a prior art bonding zone having protrusion geometry having low cross sectional contact area to both bonding substrates

FIG. 22 shows a cross sectional view of a bonding substrate having improved conductive properties to other bonding surfaces.

FIG. 23 shows a cross sectional view of a bonding substrate having trapezoidal protrusions for improved conductive properties to itself as well as to other surfaces.

FIG. 24 shows a cross sectional view of a bonding substrate having hour glass shaped protrusions for improved conductive properties to itself as well as other surfaces

FIG. 25 shows a cross sectional view of a bonding zone of the present invention having protrusion geometry with improved cross sectional contact area between bonding substrates.

FIG. 26 shows a cross sectional view of a bonding zone of the present invention having protrusion geometry with improved cross sectional contact area to both bonding substrates.

FIG. 27 shows a bonding substrate of the present invention having numerous protrusions extending outwardly from the surface.

FIG. 28 shows a cross sectional view of a bonded construction of the present invention having a high degree of thermal conductivity.

FIG. 29 shows a cross sectional view of a bonded construction of the present invention having a high degree of electrical conductivity.

FIG. 30 shows a cross sectional view of a bonded construction of the present invention having a high degree of magnetic permeability.

FIG. 31 shows a cross sectional view of a bonded construction of the present invention that interface with each other in an ultra-low profile configuration.

FIG. 32 shows a cross sectional view of a circuit component of the present invention having a heat dissipating bonding zone attached.

FIG. 33 shows a circuit component of the present invention having a heat dissipating bonding zone attached.

FIG. 34 shows a magnetic assembly of the present invention, employing two electromagnets joined together to form a magnetic assembly.

### DETAILED DESCRIPTION OF THE INVENTION

As mentioned earlier printed circuit boards are etched in a pattern required for electrically connecting individual circuit components into a functioning printed circuit. Proper design and subsequent placement of components can be used to provide relatively large areas for mounting of individual heat generating circuit components. These areas may then be masked off prior to etching to leave behind copper pads of considerable size. The individual heat producing components may then be mounted to these copper pads in a low profile horizontal position using a through hole with a nut and screw in the standard manner used to mount a traditional heat sink. Heat sink compound may be employed to provide good thermal contact between the component and copper pad of the printed circuit board. In this way, circuit component may be mounted in a low profile configuration directly onto a copper pad that is part of the printed circuit board itself. The non-etched copper pad portions of the circuit board itself now act as heat sinks. Experimental testing with this method has achieved good results. More particularly, excess heat from switching transistors has been successfully removed by employing one square inch copper pads and mounting the transistors in a planar horizontal configuration as described above. A small fan was employed to blow air over the components and the board to remove the excess heat.

One aspect of the present invention provides a significant improvement to the above described method of removing heat from individual components using copper pads on circuit boards. This method employs thermally conductive bonding agents to attach individual circuit components to their respective heat sink pads thereby eliminating the need to drill mounting holes. The heat removing copper bonding pads may employ special surface geometries that facilitate both bonding as well as the removal of heat. Eliminating holes in printed circuit boards represents a reduction in complexity and tooling costs associated with the printed circuit board assembly process.

One way of eliminating many of the holes in printed circuit boards is to employ the surface mounting technology of the present invention. This may be accomplished by having all components and connections to components on one side of the printed circuit board and mounting individual components into place on one side of the circuit board using a bonding agent. Once the bonding agent cures, component leads may be soldered into place. The result is a low profile circuit board having components firmly attached to the circuit board by both their soldered leads and the bonding agent.

The bonding areas on the circuit board surface for individual components may take numerous forms. Light etching may be used to roughen the bonding surfaces or alternatively, a special bonding surface may be prepared having numerous protrusions extending in an outward direction from the surface of the copper bonding pad. These protrusions may be made of copper or another thermally conductive metal or alternatively may be comprised of a composite material filled with copper powder or other thermally conductive filler.

So far, the heat sinking aspects of the present invention have been limited to relatively small areas of printed circuit boards. It should be noted that surface mounting of circuit components eliminates the need to drill holes through printed circuit boards. Because of this, it is now possible to employ thermally conductive materials into the individual layers of the clad board itself. In this way, the entire circuit board may function as an effective heat sink. In order to achieve this end, copper cloth or other thermally conductive material may be incorporated into the individual layers of the composite board. The exact thermally conductive structure of the board itself will of course depend on the end use application. For example, high frequency applications may require the limiting of capacitive and/or inductive effects in order to reduce capacitive and/or inductive losses. These applications may require the use of more coarse copper mesh and thermally conductive powders and less copper screen and cloth materials. Alternatively, certain applications may require RF shielding. In these instances, copper screen and cloth materials within the printed circuit board itself may provide good RF shielding and heat sinking properties simultaneously.

Copper is one of the best conductors of heat and therefore various forms of this material that are useful for producing heat conductive laminate constructions will now be described in some detail.

1) Copper Wire Mesh. Available from American Art Clay Co., Inc. 4717 W. 16th St., Indianapolis, Ind. 46222.

2) Powdered Copper. Prepared by reducing copper metal from aqueous solutions of copper sulfate using mossy zinc.

3) Powdered copper having a lacquer coating. Prepared by mixing powdered copper with a dilute solution of a lacquer material and evaporating to dryness.

4) Copper Wire Form. Available from American Art Clay Co., Inc. 4717 W. 16th St., Indianapolis, Ind. 46222.

5) Copper Wire Screen. Available from such places as McMaster Carr, This screen material is more open than copper wire mesh and comes in numerous sizes.

6) Copper coated Iron particles. Particles of iron having a thermally conductive copper outer layer. Thin layers of copper metal may be deposited on iron particles by deposition from aqueous copper sulfate solutions whereas thicker layers of copper can be electroplated onto the surface. Provides magnetic properties that may be used to hold circuit components into place during the cure process of bonding agents.

7) Copper foil having numerous holes.

8) Copper foil having etched surfaces for bonding.

9) Copper foil having electroformed surface protrusions.

Copper powder prepared by the interaction of mossy zinc with aqueous copper sulfate solutions may be used to provide good thermal conductive properties to composite circuit board materials. The preparation of this form of powdered copper along with beneficial properties and use will now be explained in some detail.

Zinc is a relatively reactive metal. It is one of the most reactive metals that may be electroplated from water based solutions. Copper is less reactive than zinc. Because of this, if a piece of zinc is placed in a water based solution of a copper salt (such as copper sulfate) the zinc will dissolve into solution and the copper will deposit on the zinc surface. The overall reaction is a displacement reaction and can be expressed as follows:

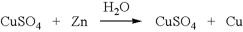

Mossy zinc is zinc metal that in the form of various small odd shapes that results from pouring molten zinc into water. This form of zinc is a useful form for displacing copper from water based solutions of copper sulfate. The following example will now be given to illustrate the preparation of a suitable form of copper powder for use in the present invention.

0.3 moles (75 grams) of copper sulfate pentahydrate were placed into a one liter glass container. To this were added 500 milliliters of distilled water. The mixture was stirred until about half of the solid dissolved. 20 grams of mossy zinc (slightly over 0.3 moles) were added and the mixture allowed to stand for twenty minutes. The mixture was lightly stirred every fifteen minutes until all of the copper sulfate had dissolved and the resultant solution rendered clear (indicating that no more copper sulfate was present). The copper powder was then collected on filter paper and the residual pieces of zinc removed. The copper powder was then rinsed with one liter of distilled water and allowed to drip dry. The resulting copper paste was placed on fresh filter paper to absorb more water. The semi-dry copper paste was then placed on a piece of fresh filter paper and allowed to air dry to constant weight. The dried copper powder was then removed and weighed. The mass of copper powder was found to be 18.5 grams (0.291 moles). This corresponds to a yield of 97%. The resulting powder was a dark reddish tan color.

The above prepared copper powder was then mixed with epoxy resin in order to determine proper loading density. It was found that 65% loading density resulted in a relatively thin paste and that up to 75% by weight of added copper powder could be mixed in before becoming too difficult to work with. The epoxy resin used was West Systems 105 resin. This was cured with the recommended amount of 205 hardener. West System Inc PO Box 665 Bay City, Mich. 48707. The copper loaded epoxy resin compositions were allowed to cure at room temperature for 24 hours. Inspection of the cured copper loaded epoxy revealed a uniform distribution of copper powder in the mix along with good thermal conductivity. Subsequent surface testing using an Ohm meter revealed good electrical insulating properties to the low voltages used in the test.

It should be noted that in some instances it may be desirable to drill holes through a circuit boards for special purposes. For example, it may be desirable to make a solid electrical connection from one side of the board to the other. In such instances, heat conductive copper within the board itself may be eliminated in select areas prior to assembly of the composite board laminate. In other words, areas of thermal conductivity within the circuit cladding itself may have desirable patterns that leave spaces for the drilling of through holes. Employing patterns of thermally conductive copper within the composite portions of printed circuit boards broadens their use by separating the board into discrete areas of high heat transfer and into discrete areas where it is not desirable to have copper materials embedded within the inner layers of the board.

It should be noted that it may be desirable to employ the surface mounting of components on both sides of the printed circuit board and have areas in the board that are free from internal copper. These areas may be used for drilling holes through the board to make electrical connections from one side to the other without interference from internal electrically conductive copper.

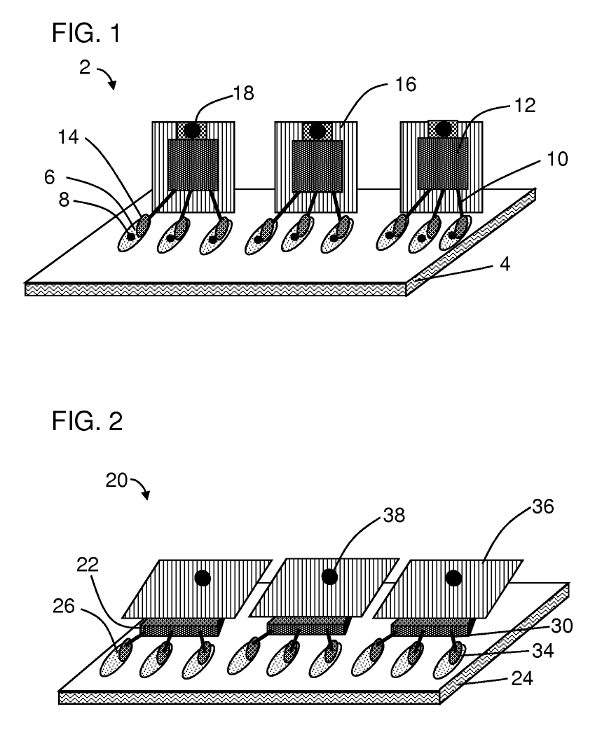

FIG. 1 shows a standard printed circuit board employing vertically mounted components along with attached heat sinks. Printed circuit board 2 is shown having board portion 4 along with soldering pad portions 6. Also shown are holes 8 in etched soldering pad portions 6 are ased to attach leads 10 from components 12 using solder 14. Components 12 are held into place in a vertical position by their leads 10. Heat sinks 16 are shown attached to components 12 with small rivets 18. Small rivets 18 hold components 12 tightly against heat sinks 16. Thermally conductive heat sink compound (not shown) is used to provide good thermal contact between components 12 and heat sinks 16.

FIG. 2 shows a printed circuit board employing surface mounting of components. Circuit board 20 employing surface mounting of components 22 is shown having board portion 24 along with etched soldering pad portions 26. Also shown are leads 30 from components 22 attached to soldering pad portions 26 using solder 34. Components 22 are held into a horizontal position by their leads 30. Heat sinks 36 are shown attached to components 22 with small rivets 38. Rivets 38 hold components 22 tightly against heat sinks 36. Thermally conductive heat sink compound (not shown) is used to provide good thermal conductivity between components 22 and heat sinks 36.

FIG. 2 clearly shows the more planar configuration of surface mounted components on their respective circuit boards when compared to the standard vertical mounted components shown on the circuit board of FIG. 1. It should be noted that no holes are required for component leads because the solder holds them firmly into place. Heat sinks 36 in FIG. 2 are shown in a more planar configuration than heat sinks 16 shown in FIG. 1. The reduction in the need for lead holes coupled with the lower profile of individual circuit components serves to illustrate certain advantages offered by surface mount technology.

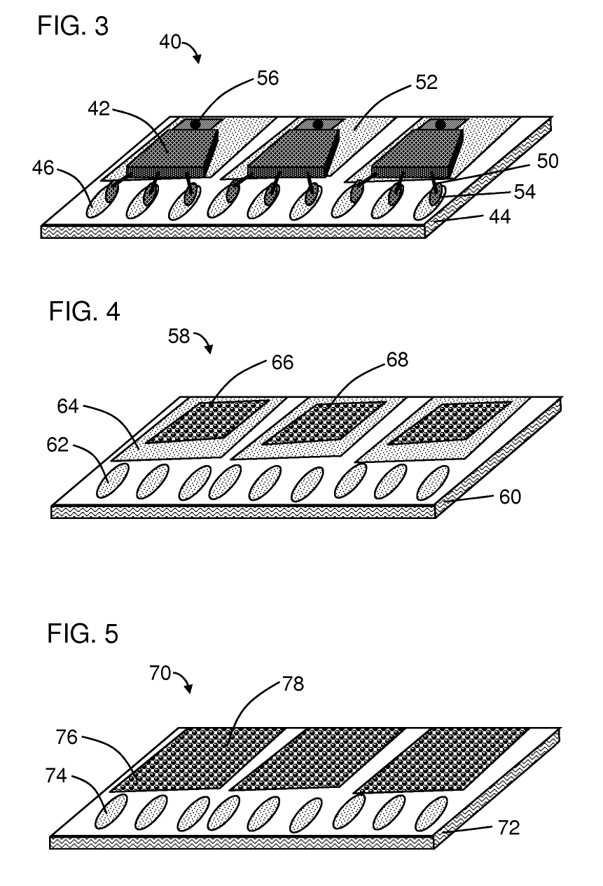

FIG. 3 shows a printed circuit board employing surface mount components and copper pads for heat dissipation without the need for added heat sinks. Circuit board 40 employing surface mounting of components 42 is shown having board portion 44 along with etched soldering pad portions 46. Also shown are leads 50 from components 42 attached to soldering pad portions 46 using solder 54. Heat sink pads 52 on circuit board 40 are shown as part of circuit board 40 and are formed during the original etching process. Heat sink pads 52 on circuit board 40 are formed in the same manner as soldering pad portions 46. In this respect, little additional effort is required resulting in the elimination of heat sinks 36 of FIG. 2. Rivets 56 hold components 42 firmly into place. Thermally conductive heat sink compound (not shown) is used to provide good thermal conductivity between components 42 and heat sink pads 52.

While advantageous in numerous applications, it is to be understood that the heat sinking capabilities of printed circuit boards in their present state may be somewhat limited. It should also be noted that holes must be drilled into circuit boards in order to firmly attach individual components to their etched heat sink pads.

FIG. 4 shows a printed circuit board of the present invention having a heat dissipating bonding area for attaching heat generating components with a bonding agent.

Circuit board 58 is shown having board portion 60 along with etched soldering pad portions 62. Also shown are heat sink pads 64 as part of circuit board 58 and are formed during the original etching process. Heat sink pads 64 on circuit board 58 are formed in the same manner as soldering pad portions 62. In this respect, little additional effort is required resulting in the elimination of heat sinks 36 of FIG. 2. Also shown are bonding pads 66 having numerous protrusions 68 extending in an outward direction. These protrusions promote the bonding of circuit components with bonding agents.

The protrusions themselves may be formed from the original bonding pads by electroplating through a patterned mask. This process is known as electroforming. The electroforming process produces protrusions that are part of the copper pad underneath and therefore possess good strength and thermal conductivity.

Other possible methods for producing thermally conductive bonding protrusions include the following:

1) Bonding small copper beads in a pattern on the heat sink pads using electrically conductive epoxy and electroplating over the entire surface.

2) Etching the heat sink pad surface to promote adhesion followed by silk screening on conductive epoxy and then electroplating over the entire area.

3) Etching the heat sink pad surface to promote adhesion followed by using a thermally conductive bonding agent to attach pre-cut copper foil having electroformed surface protrusions.

4) Etching the heat sink pad surface to promote adhesion followed by silk screening a pattern of thermally conductive protrusions.

Thermally conductive bonding pad 66 eliminates the need to drill mounting holes, may be used to hold components into place prior to soldering operations, keeps components firmly attached to their circuit boards, and helps to remove of excess heat.

FIG. 5 shows a printed circuit board of the present invention having numerous surface protrusions extending beyond the bonding zone for improved heat dissipation.

Circuit board 70 is shown having board portion 72 along with etched soldering pad portions 74. Also shown are heat sink bonding pads 76 having numerous protrusions 78 for attaching circuit components and removing heat. Protrusions 78 extend past the component bonding zone and provide added exposed surfaces for dissipating heat.

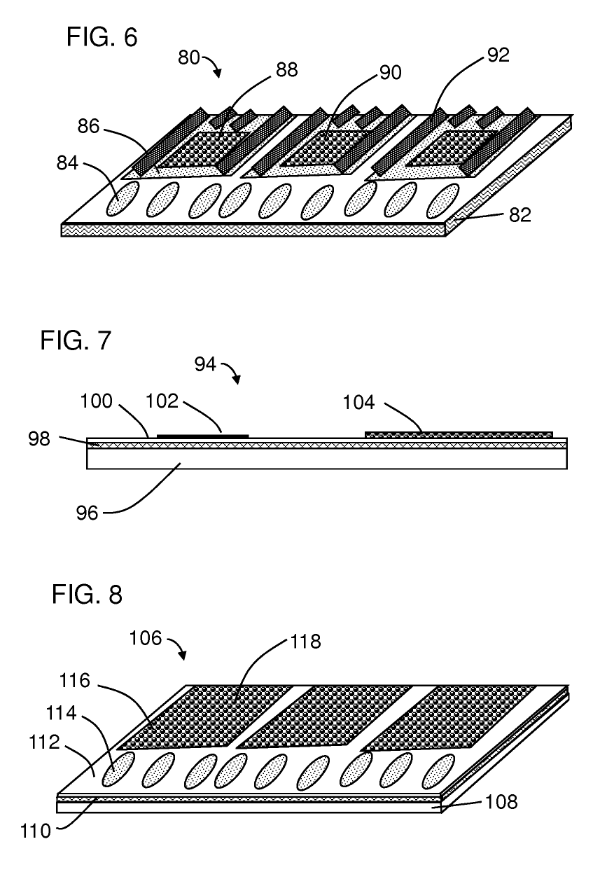

FIG. 6 shows a printed circuit board of the present invention having a heat dissipating bonding area for attaching heat generating components with a bonding agent along with added copper fins extending beyond the bonding zone for improved heat dissipation. Circuit board 80 is shown having board portion 82 along with etched soldering pad portions 84. Also shown are heat sink bonding pads 86 having heat dissipating bonding areas 88. Also shown are numerous protrusions 90 for attaching circuit components and removing heat. Heat dissipating metal fins 92 extend past the component bonding zone and provide added exposed surfaces for dissipating heat. The heat dissipating fins may be made from numerous materials, however copper is a preferred material owing to its high thermal conductivity. It should be noted that copper foil may be soldered directly to heat sink bonding pads 86.

The addition of fins to heat sink bonding pads 86 provides a relatively easy way to remove excess heat. This excess heat may dissipate by the natural mechanisms of convection, conduction, and radiation. Alternatively a fan may be placed near the bonding pad to provide additional cooling. Additional cooling may be added by the incorporation of thermally conductive material to the interior portions of the circuit board itself. This aspect of the present invention is shown in FIG. 7.

FIG. 7 shows cross sectional view of a printed circuit board of the present invention having a heat dissipating bonding area for attaching heat generating components with a bonding agent along with an internal metal mesh for transferring heat throughout the entire board. Heat dissipating circuit board 94 is shown having a bottom composite portion 96 and a heat conductive metal mesh portion 98. Also shown is top composite portion 100 along with soldering pad 102 and thermally conductive bonding pad 104. As usual, thermally conductive bonding pad 104 forms a suitable surface for bonding circuit components with a thermally conductive bonding agent. Such bonding agents may be prepared by adding thermally conductive materials such as copper powder to liquid bonding agents such as epoxy resins.

Heat produced from circuit components bonded to bonding pad 104 of printed circuit board 94 is conducted into bonding pad 104 where it spreads out and transfers through top composite portion 100 and into metal mesh portion 98. Metal mesh portion 98 then dissipates this heat throughout the entire circuit board.

The metal mesh used in mesh portion 98 of heat dissipating circuit board 94 may be made from numerous metals including aluminum and copper. The mesh itself may take numerous forms such as WireForm, screen, and woven cloth. The particular metal mesh used will be determined at least in part by the particular application. For example, circuitry running at relatively high frequency and or high alternating currents may benefit from a relatively open mesh such as WireForm in order to reduce capacitive and inductive effects. On the other hand, low frequency circuits requiring a high degree of heat dissipation may benefit from woven copper cloth.

Top composite portion 100 serves to electrically isolate metal mesh portion 98 from bonding pad 104. Bottom composite portion 96 and top composite portion 100 may contain thermally conductive additives such as powdered metals and their oxides. These additives may be employed to further enhance the overall thermal conductive and heat dissipating properties of heat dissipating printed circuit board 94.

FIG. 8 shows a printed circuit board of the present invention having numerous surface protrusions extending beyond the bonding zone for improved heat dissipation along with internal metal mesh for transferring heat throughout the entire board. Heat dissipating circuit board 106 is shown having bottom composite portion 108 and a heat conductive metal mesh portion 110. Also shown is top composite portion 112 along with etched soldering pads 114. Also shown are heat sink bonding pads 116 having numerous protrusions 118 for attaching circuit components and removing heat. Protrusions 118 extend past the component bonding zone and provide added exposed surfaces for dissipating surface heat while metal mesh portion 110 dissipates heat from underneath heat sink bonding pads 116 as described in detail above in FIG. 7.

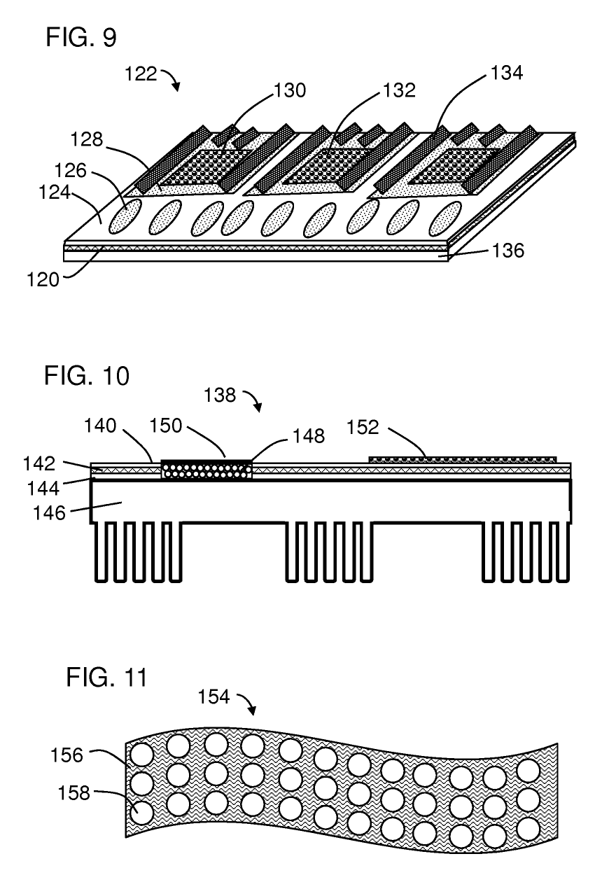

FIG. 9 shows a printed circuit board of the present invention having a heat dissipating bonding area for attaching heat generating components with a bonding agent along with added copper fins extending beyond the bonding zone for improved heat dissipation and internal metal mesh for transferring heat throughout the entire board. Heat dissipating circuit board 122 is shown having bottom composite portion 136 and a heat conductive metal mesh portion 120. Also shown is top composite portion 124 along with etched soldering pads 126. Also shown are heat sink pads 128 along with heat sink bonding pads 130 having numerous protrusions 132 for attaching circuit components and removing heat. Copper fins 134 extend past the component bonding zone and provide added exposed surfaces for dissipating surface heat while metal mesh portion 120 dissipates heat from underneath heat sink bonding pads 128 as described in detail above in FIG. 7.

FIG. 10 shows cross sectional view of a printed circuit board of the present invention having a heat dissipating bonding area for attaching heat generating components with a bonding agent, internal metal mesh for transferring heat throughout the entire board, an attached heat sink, and added thermal insulation under the soldering zones. Heat dissipating printed circuit board with attached heat sink 138 is shown having thin film top composite portion 140 along with thermally conductive internal metal mesh portion 142 and thin film composite bottom portion 144. Thin film top and bottom composite portions 140 and 144 respectively serve to provide electrical insulation while providing significant heat sinking capabilities to heat dissipating printed circuit board 138. Heat insulating zone 148 is also shown. Heat insulating zone 148 is located underneath etched soldering pad 150. Heat insulating zone 148 provides thermal insulation between soldering pad 150 and heat sink portion 146. Heat insulating zone 148 helps to prevent excessive heat sinking of soldering pad 150 thereby allowing ease of soldering without excessive removal of heat.

When soldering component leads onto their copper pads, rapid removal of heat may result in cold solder joints of poor quality. Adding zones of insulation to printed circuit boards may help to improve solder joints by keeping the heat within the soldered joint long enough to allow proper solder flow prior to its solidification. Numerous materials may be employed to improve heat insulating properties of printed circuit boards. One material is Dicaperl available from Plastic Depot. 2907 San Fernando Blvd. Burbank, Calif. 91504. Dicaperl is a lightweight filler used in composites. It is comprised of numerous hollow glass micro-spheres. This thermally insulating material may be mixed with resin and employed in discrete zones within the internal portions of printed circuit boards.

Employing discrete thermally insulating zones of glass micro-sphere filled composites in printed circuit boards having enhanced thermal conductivity provides easy soldering of component leads. This may be of particular value when employing circuit boards having enhanced thermal conductivity that may be fixedly attached to heat sinks. Insulating zone 148 may be comprised of hollow glass micro-spheres embedded into a polymer resin such as epoxy.

FIG. 11 shows a thin thermally conductive metal sheet having numerous holes to promote bonding within the interior portions of a composite printed circuit board. Perforated metal sheet 154 is shown having metal foil portion 156 along with holes 158. Holes 158 allow bonding agents during circuit board manufacture to flow through perforated metal sheet 154 and form continuous bonding between composite layers just above and below perforated metal sheet 154.

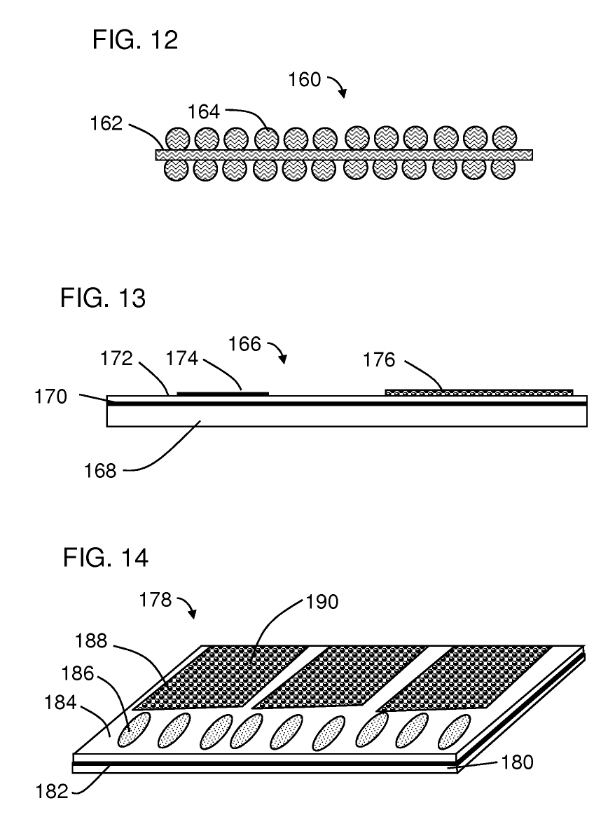

FIG. 12 shows a thin thermally conductive metal sheet having numerous protrusions to promote bonding within the interior portions of composite printed circuit boards. Pre-beaded metal sheet 160 is shown having metal foil portion 162 along with protrusions 164 extending in an outward direction from metal foil portion 162. Protrusions 164 promote bonding to adjacent layers within the internal structure of printed circuit boards. Pre-beaded metal sheet 160 may be made from copper or other metal possessing a high degree of thermal conductivity.

Protrusions 164 are shown as part of metal foil portion 162. This may be accomplished by means of electroforming through a suitable pattern of photoresist.

FIG. 13 shows cross sectional view of a printed circuit board of the present invention having a heat dissipating bonding area for attaching heat generating components with a bonding agent along with internal metal foil for transferring heat throughout the entire board. Heat dissipating circuit board 166 is shown having a bottom composite portion 168 and a heat conductive metal foil portion 170. Also shown is top composite portion 172 along with soldering pad 174 and thermally conductive bonding pad 176. As usual, thermally conductive bonding pad 176 forms a suitable surface for bonding circuit components with a thermally conductive bonding agent. Such bonding agents may be prepared by adding thermally conductive materials such as copper powder to liquid bonding agents such as epoxy resins.

Heat produced from circuit components bonded to bonding pad 176 of printed circuit board 166 is conducted into bonding pad 176 where it spreads out and transfers through top composite portion 172 and into metal foil portion 170. Metal foil portion 170 then dissipates this heat throughout the entire circuit board.

The metal foil used in portion 170 of heat dissipating circuit board 166 may be made from numerous metals including aluminum and copper. The foil itself may take numerous forms such as having holes or surface protrusions. The particular metal foil used will be determined at least in part by the particular application.

Top composite portion 172 serves to electrically isolate metal foil portion 170 from bonding pad 176. Bottom composite portion 168 and top composite portion 172 may contain thermally conductive additives such as powdered metals and their oxides. These additives may be employed to further enhance the overall thermal conductive and heat dissipating properties of heat dissipating printed circuit board 166.

FIG. 14 shows a printed circuit board of the present invention having numerous surface protrusions extending beyond the bonding zone for improved heat dissipation along with internal metal sheet for transferring heat throughout the entire board. Heat dissipating circuit board 178 is shown having bottom composite portion 180 and a heat conductive metal foil portion 182. Also shown is top composite portion 184 along with etched soldering pads 186. Also shown are heat sink bonding pads 188 having numerous protrusions 190 for attaching circuit components and removing heat. Protrusions 190 extend past the component bonding zone and provide added exposed surfaces for dissipating surface heat while metal foil portion 182 dissipates heat from underneath heat sink bonding pads 188 as described in detail above in FIG. 13.

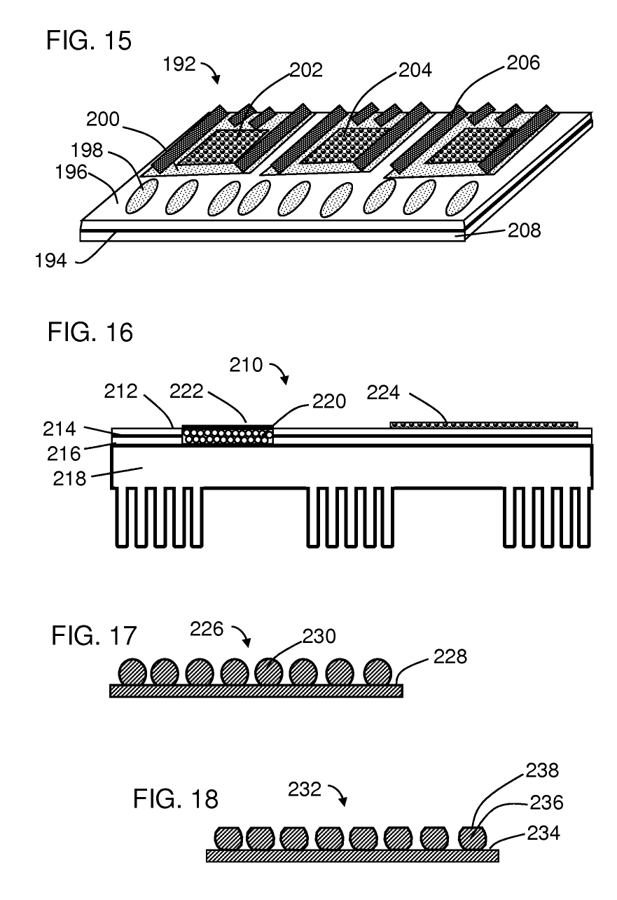

FIG. 15 shows a printed circuit board of the present invention having a heat dissipating bonding area for attaching heat generating components with a bonding agent along with added copper fins extending beyond the bonding zone for improved heat dissipation and internal metal sheet for transferring heat throughout the entire board. Heat dissipating circuit board 192 is shown having bottom composite portion 208 and a heat conductive metal foil portion 194. Also shown is top composite portion 196 along with etched soldering pads 198. Also shown are heat sink pads 200 along with heat sink bonding pads 202 having numerous protrusions 204 for attaching circuit components and removing heat. Copper fins 206 extend past the component bonding zone and provide added exposed surfaces for dissipating surface heat while metal foil portion 194 dissipates heat from underneath heat sink bonding pads 200 as described in detail above in FIG. 13.

FIG. 16 shows cross sectional view of a printed circuit board of the present invention having a heat dissipating bonding area for attaching heat generating components with a bonding agent, internal metal sheet for transferring heat throughout the entire board, an attached heat sink, and added thermal insulation under the soldering zones. Heat dissipating printed circuit board with attached heat sink 210 is shown having thin film top composite portion 212 along with thermally conductive internal metal foil portion 214 and thin film composite bottom portion 216. Thin film top and bottom composite portions 212 and 216 respectively serve to provide electrical insulation while providing significant heat sinking capabilities to heat dissipating printed circuit board 210. Heat insulating zone 220 is also shown. Heat insulating zone 220 is located underneath etched soldering pad 222. Heat insulating zone 220 provides thermal insulation between soldering pad 222 and heat sink portion 218. Heat insulating zone 220 helps to prevent excessive heat sinking of soldering pad 222 thereby allowing ease of soldering without excessive removal of heat.

When soldering component leads onto their copper pads, rapid removal of heat may result in cold solder joints of poor quality. Adding zones of insulation to printed circuit boards may help to improve solder joints by keeping the heat within the soldered joint long enough to allow proper solder flow prior to its solidification. Numerous materials may be employed to improve heat insulating properties of printed circuit boards. One material is Dicaperl available from Plastic Depot. 2907 San Fernando Blvd. Burbank, Calif. 91504. Dicaperl is a lightweight filler used in composites. It is comprised of numerous hollow glass micro-spheres. This thermally insulating material may be mixed with resin and employed in discrete zones within the internal portions of printed circuit boards.

Employing discrete thermally insulating zones of glass micro-sphere filled composites in printed circuit boards having enhanced thermal conductivity provides easy soldering of component leads. This may be of particular value when employing circuit boards having enhanced thermal conductivity that may be fixedly attached to heat sinks. Insulating zone 220 may be comprised of hollow glass micro-spheres embedded into a polymer resin such as epoxy.

FIG. 17 shows a cross sectional view of a thermally conductive bonding pad of the present invention having numerous spherical protrusions. Thermally conductive metal foil bonding pad 226 is shown comprised of metal foil substrate portion 228 along with numerous protrusions 230. Protrusions 230 may be formed into a single piece with foil substrate portion 228 by a suitable process such as electroforming.

FIG. 18 shows a cross sectional view of a thermally conductive bonding pad of the present invention having numerous protrusions having a spherical base and flat top geometry. Thermally conductive metal foil bonding pad 232 having flat top geometry is shown comprised of metal foil substrate portion 234 along with numerous protrusions 236. Protrusions 236 may be formed into a single piece with foil substrate portion 234 by a suitable process such as electroforming. Flat top geometry portions 238 of protrusions 236 provide low profile contact with circuit components while at the same time maintaining good bonding characteristics with bonding agents along with good heat transfer characteristics. Such flat top geometry may be formed in numerous ways including lapping of the round top protrusions illustrated in FIG. 17.

Numerous methods may be employed to hold individual components in place during the cure of the bonding agent. Numerous methods may be employed including pressing down with silicone rubber sheets, the implementing of various fixtures, and the spring action of previously soldered leads. Of particular interest is the use of magnets for holding individual circuit components into place during the cure cycle of bonding agents. Numerous magnet types may be used including ceramic and rare earth. A piece of steel or other magnetic material may be placed on the back side of the circuit board for this purpose.

Another option for magnetically holding individual circuit components into place involves the addition of magnetic materials to the printed circuit boards themselves for this purpose. Numerous forms of magnetic material may be used including steel sheet, iron wire and cloth made from iron and its magnetic alloys. Of particular interest is the addition of powdered iron into the composite layers of printed circuit boards. The powdered iron may by coated with copper, or alternatively may be mixed with copper to further improve thermal conductivity. Other magnetic materials including magnetic iron oxide may be used as well.

FIG. 19 shows a cross sectional view of a circuit component being held into place with a magnet during the bonding agent cure cycle. Heat dissipating circuit board 240 is shown having a bottom composite portion 242 and a heat conductive metal mesh portion 244. Also shown is top composite portion 246 along with soldering pad 248 and thermally conductive bonding pad 250. As usual, thermally conductive bonding pad 250 forms a suitable surface for bonding circuit components with a thermally conductive bonding agent. Such bonding agents may be prepared by adding thermally conductive materials such as copper powder to liquid bonding agents such as epoxy resins.

Heat produced from circuit components bonded to bonding pad 250 of printed circuit board 240 is conducted into bonding pad 250 where it spreads out and transfers through top composite portion 246 and into metal mesh portion 244. Metal mesh portion 244 then dissipates this heat throughout the entire circuit board.

Magnetic section 252 is shown located directly below circuit component 254. Magnetic section 252 is composed of a magnetic material such as powdered iron composite. Magnetic section 252 may be used to hold circuit component into place with permanent magnet 256 during the bonding agent cure cycle. Once the bonding agent is cured, permanent magnet 256 may then be removed.

Special attention will now be paid to the ultra low profile bonding aspects of the present invention and their resulting advantageous properties with respect to thermal dissipation.

FIG. 20 shows a cross sectional view of a prior art bonding substrate having interlocking properties to bonding agents. Bonding surface 258 is shown prepared in accordance with the prior art invention U.S. Pat. No. 6,692,813. Bonding surface 258 is prepared having continuous phase between spherical particles 260 attached to substrate 262 at attachment points 264. Attachment points 264 are unusually strong owing to their continuous phase characteristics and therefore require only minimal cross sectional area. The result is strong bond between spherical particles 260 and substrate 262 that has significant undercut for interlocking with liquid bonding agents.

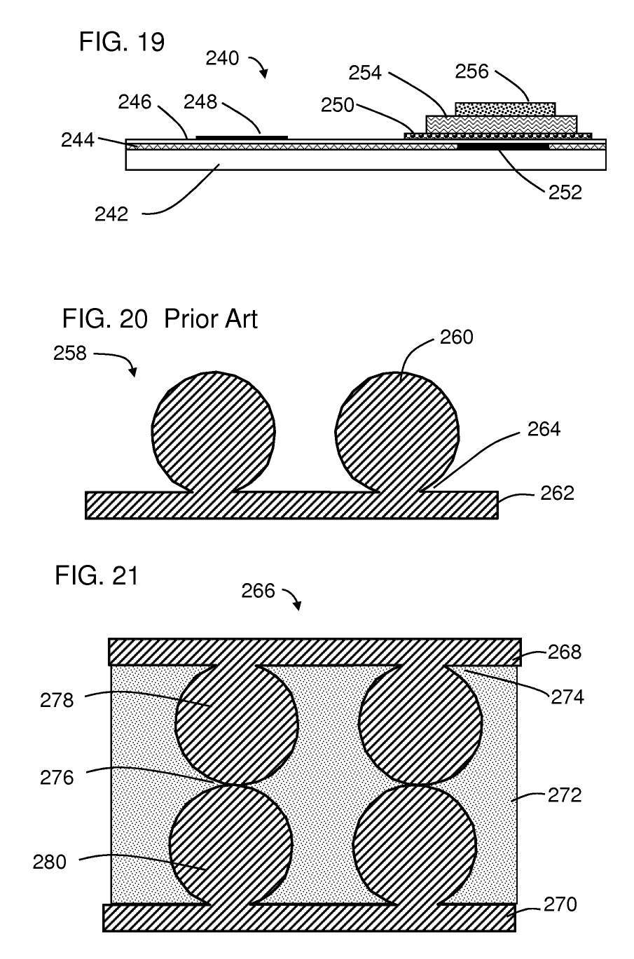

FIG. 21 shows a cross sectional view of a prior art bonding zone having protrusion geometry having low cross sectional contact area to both bonding substrates. Bonding construction 266 is shown having top bonding surface 268 firmly bonded to bottom bonding surface 270 with bonding agent 272. Both top bonding surface 268 and bottom bonding surface 270 are shown configured in the same manner as bonding substrate 262 of FIG. 20. Bonding construction 266 therefore falls within the scope of the prior art outlined in U.S. Pat. No. 6,692,813. It should be noted that the very aspects that provide exceptional strength to bonding construction 266 tend to reduce thermal conductivity, and/or electrical conductivity, and/or magnetic permeability across the bonding zone. In particular, the small cross sectional area of attachment points 274 may provide resistance to the flow of heat and electricity in copper substrates and may provide resistance to the flow of magnetic flux in substrates comprised of magnetic materials. It should also be noted that the overall thickness of bonding construction 266 may be substantial on a microscopic scale. Also shown is contact point 276 which is very small in area owing to the fact that it results from spherical particle 278 lightly contacting spherical particle 280. Because of this, contacting point 276 between spherical particles 278 and 280 represents a point of high resistance to the flow of heat and electricity in copper substrates and may provide resistance to the flow of magnetic flux in substrates comprised of magnetic materials.

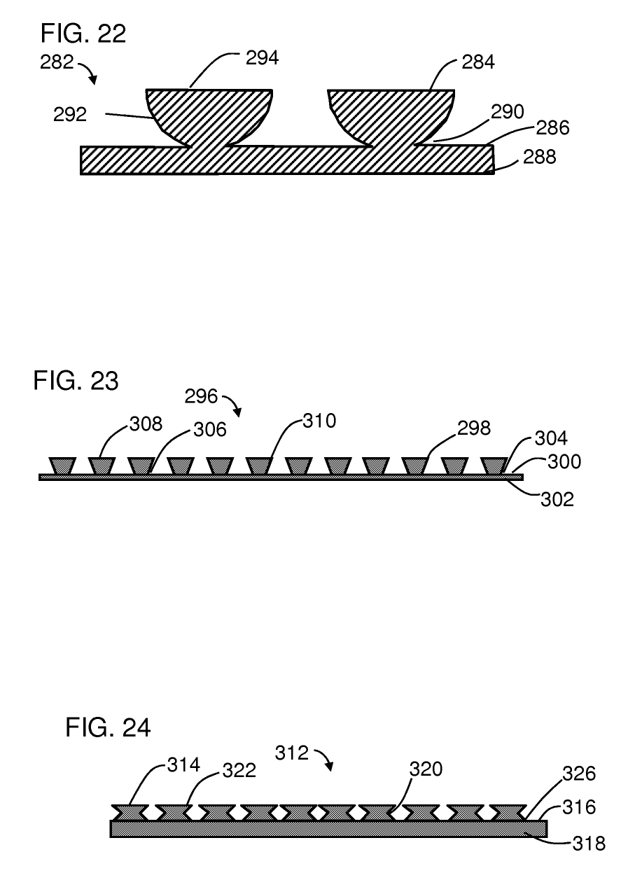

FIG. 22 shows a cross sectional view of a bonding substrate having improved conductive properties to other bonding surfaces. Bonding surface 282 is comprised of hemispherical protrusions 284 extending outwardly from top portion 286 of lower base portion 288. Also shown is undercut zone 290 located between lower curved portion 292 of hemispherical protrusions 284 and top portion 286 of lower base portion 288. Undercut zone 290 between lower curved portion 292 of hemispherical protrusion 284 and top portion 286 of lower base portion 288 provides interlocking properties with liquid bonding agents (not shown). Also shown are flat top portions 294 of hemispherical protrusions 284. Flat top portions 294 of hemispherical protrusions 284 have a high cross sectional value and therefore may be used to provide improved thermal and electrical conductive properties in substrates made from electrically conductive and/or thermally conductive materials such as copper, and improved magnetic permeability in substrates composed of magnetic materials compared with bonding surface 258 of the prior art outlined in FIG. 20.

The hemispherical protrusions of FIG. 22 may be formed in numerous ways. For example, the lost wax process may be employed as in U.S. Pat. No. 6,692,813. The protrusions may be decked flat in the wax prior to forming the mold, or alternatively the finished part having spherical shaped protrusions may be surface ground to remove the top half of the spherical protrusions. In addition, numerous other methods may be employed. For example, electroforming operations may be carried out to plate out materials through a patterned masking agent such as photo resist.

Electroforming involves plating of metal through a patterned mask that covers a conductive surface. In short, metal is deposited in a pattern by the process of electroplating. Electroplating and electroforming operations are well known art and therefore significant detail of these operations be given here.

Undercut zone 290 while providing interlocking properties to bonding agents often results in a relatively small cross sectional area of attachment between top portion 286 of base portion 288 and lower curved portion 292 of hemispherical protrusion 284. This may result in a zone of high thermal resistance, and/or electrical resistance, and/or low magnetic permeability. FIGS. 23 and 24 shown below illustrate interlocking bonding surfaces of the present invention having protrusion geometries suitable for enhancing thermal conductivity, electrical conductivity, and magnetic permeability.

FIG. 23 shows a cross sectional view of a bonding substrate having trapezoidal protrusions for improved conductive properties to itself as well as to other surfaces. Bonding surface 296 is comprised of protrusions 298 having trapezoidal cross section extending outwardly from top surface portion 300 of lower base portion 302. Also shown is undercut zone 304 located between lower narrower portion 306 of trapezoidal protrusions 298 and top surface portion 300 of lower base portion 302. Undercut zone 304 located between lower narrower portion 306 of trapezoidal protrusions 298 and top surface portion 300 of lower base portion 302 provides interlocking properties with liquid bonding agents (not shown). Also shown are flat top portions 308 of trapezoidal protrusions 298. Flat top portions 308 of trapezoidal protrusions 298 have a high cross sectional value and therefore may be used to provide good thermal and electrical conductive properties in substrates made from electrically conductive and/or thermally conductive materials such as copper and good magnetic permeability in substrates composed of magnetic material. Also shown are attachment zones 310 which attach trapezoidal protrusions 298 to top surface portion 300 of lower base portion 302. It should be noted that attachment zones 310 of bonding surface 296 may have greater cross sectional area than the attachment zones connecting hemispherical protrusions 284 from top portion 286 of lower base portion 288 of FIG. 22.

FIG. 24 shows a cross sectional view of a bonding substrate having hour glass shaped protrusions for improved conductive properties to itself as well as other surfaces. Bonding surface 312 is comprised of protrusions 314 having an hourglass cross section extending outwardly from top surface portion 316 of lower base portion 318. Also shown is interlocking bonding zone 320 resulting from the hourglass geometry of protrusions 314. Interlocking bonding zone 320 provides interlocking properties with liquid bonding agents (not shown). Also shown are flat top portions 322 of hourglass protrusions 314, and flat bottom portions 324 of protrusions 314. Flat top portions 322 of hourglass protrusions 314 have a high cross sectional value and therefore may be used to provide good thermal and electrical conductive properties in substrates made from electrically conductive and/or thermally conductive materials such as copper and good magnetic permeability in substrates composed of magnetic material. Also shown are attachment zones 326 which attach hour glass shaped protrusions 314 to top surface portion 316 of lower base portion 318. It should be noted that attachment zones 326 of bonding surface 312 may have greater cross sectional area than the attachment zones 310 connecting trapezoidal protrusions 298 from top surface portion 300 of lower base portion 302 of FIG. 23.

The hourglass shaped protrusions illustrated in FIG. 5 may be configured to provide good interlocking properties to liquid bonding agents while at the same time providing high cross sectional bonding surfaces and attachment zones to underlying base surfaces having high cross sectional values as well.

The hourglass shaped protrusions illustrated in FIG. 5 may be prepared by employing the operations of plating, etching, electroforming, and electro-etching. For example, a sample of copper clad circuit board material may be electroplated to a copper thickness of half of the hour glass height. A mask of photo-resist may then be applied over the copper surface and exposed to UV light using a contact mask having a pattern of exposure that will result in numerous small circles of photo-resist remaining on the copper surface after the developing process. The developed board may then be etched for just long enough to expose the board beneath the copper. This process may be used to form the lower half of the hourglass protrusions. By careful control of the etch time, the protrusions that result can be made to have a wider base than top surface portion. At this point, the photo-resist may be stripped away, the board cleaned, and a liquid etch mask applied to a level just below the exposed top surfaces of the protrusions. Electroforming operations may then be carried out to form the top half of the hourglass shape. The board may then be rinsed off, the etch mask removed, and thoroughly cleaned.

Other possibilities include laminating, exposing, and developing multiple layers of photo-resist to build up a pattern having internal voids having an hourglass shape and electroforming to replace the void with a suitable material such as copper.

In certain instances it may be possible to directly etch hourglass shaped protrusions into a metal surface by controlling the etch process itself. A developed copper clad board having photo-resist remaining in a pattern of circles in theory should etch out cylindrical shaped protrusions. However, if during the etch process a greater supply of etchant is available to the central portions than the top and bottom portions, the cylindrical shape may be modified significantly. More particularly this modification would tend to result in protrusions having an hourglass shape. In addition, metals having different etch rates may be plated in subsequent layers. Etching these constructions may result in different etch rates from top to bottom thereby modifying the overall protrusion geometry.

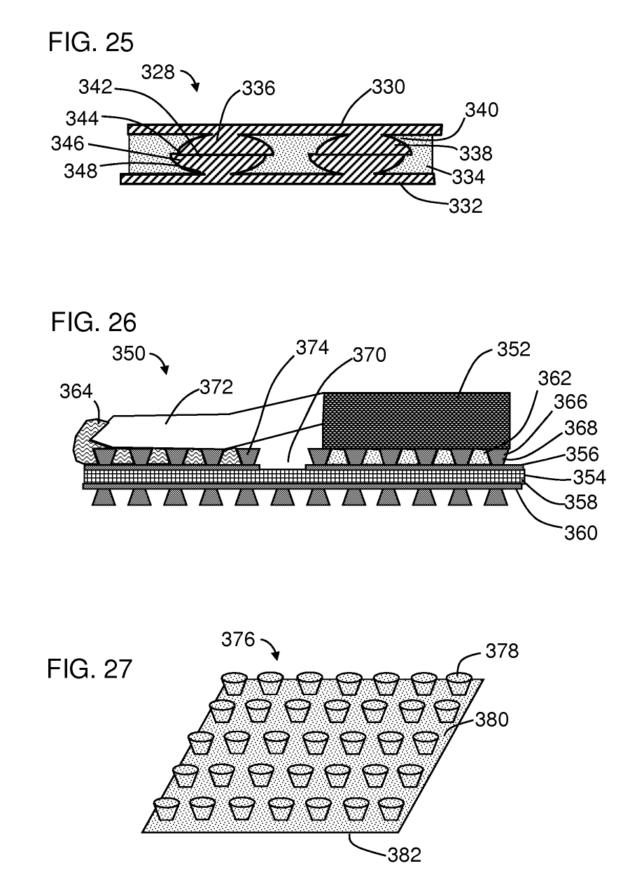

FIG. 25 shows a cross sectional view of a bonding zone of the present invention having protrusion geometry with improved cross sectional contact area between bonding substrates. Bonding construction 328 is comprised of top portion 330, bottom portion 332, and central bonding agent portion 334. Top portion 330 and bottom portion 332 are shown in detail in FIG. 22. The conductive properties of bonding construction 328 may be considerably greater than the conductive properties of bonding construction 266 of the prior art of FIG. 21. The thermal conductive properties of the geometric aspects of bonding construction 328 will now be described in detail. Top portion 330 may be made from a high thermally conductive material such as copper. Heat present in top portion 330 of bonding construction 328 will rapidly transfer throughout the entire mass. There will be some resistance from heat transfer between top surface portion 336 and top hemispherical protrusions 338. Resistance to the transfer of heat between top surface portion 336 and hemispherical protrusions 338 may occur at narrow attachment zone 340 (improvements in cross section at attachment zones are illustrated in detail in FIGS. 23 and 24). The source of heat entering top portion 330 may come from bonded electrical components or alternatively, top portion 330 may be the bottom surface of an electrical component itself constructed in accordance with the low profile interlocking aspects of the present invention. Heat from top portion 330 may be removed by the process of thermal conduction. Heated top surface 330 may transfer heat to thermally conductive bonding agent portion 334 along all of its contacting surfaces. Heat may then flow through thermally conductive bonding agent portion 334 and into bottom portion 332. Heat transfer may occur more efficiently through the pathway of least bonding agent present in bonding agent portion 334 and less efficiently through pathways having greater distances of travel through the bonding agent comprising bonding agent portion 334. In particular, good thermal conduction between top portion 330 and bottom portion 332 along the following pathway. Heat present in top portion 328 may flow from flat surfaces 342 of hemispherical protrusions 338 into top flat surfaces 344 of hemispherical protrusions 346 through a minimal amount of bonding agent. Heat in hemispherical protrusions 346 may then spread into bottom portion 332 through narrow attachment zone 348. It should be noted that significant heat transfer may occur throughout the other areas of bonding agent 334. This effect may be further enhanced by incorporating thermally conductive fillers into bonding agent portion 334. Narrow attachment zones 340 and 348 provide areas of undercut for interlocking with liquid bonding agents. The relatively low cross sectional values of narrow attachment zones 340 and 348 may be somewhat restrictive to the flow of heat. Because of this, geometries having larger cross sectional values may be desirable for certain applications. Two of these more favorable geometries are described in detail in FIGS. 23 and 24.

FIG. 26 shows a cross sectional view of a bonding zone of the present invention having protrusion geometry with improved cross sectional contact area to both bonding substrates. Bonded construction 350 is shown having heat generating electrical component 352 fixedly attached to bonding substrate 354. Thermally conductive bonding substrate 354 is composed of thermally conductive bonding top surface portion 356, thin electrically insulating layer 358, and thermally conductive bonding bottom surface portion 360. Thermally conductive bonding top surface portion 356 and thermally conductive bottom bonding surface portion 360 are made of copper and therefore conduct heat as well as electricity. Also shown is thermally conductive bonding agent 362 and electrically conductive solder 364. Thermally conductive bonding top surface 356 is shown comprised of numerous trapezoidal protrusions 366 extending outwardly from upper copper clad portion 368. Heat generating electrical component 352 is shown bonded to thermally conductive bonding top portion with thermally conductive bonding agent 362. It should be noted that thermally conductive bonding agent 362 forms an interlocking bond to numerous trapezoidal protrusions 366 extending outwardly from upper copper clad portion 368. Thermally conductive bonding agent 362 may also form an interlocking bond to numerous electrical components via through holes and by encapsulation. Heat from heat generating electrical component 362 may therefore flow into the attached portion of thermally conductive top surface portion 356 thereby immediately removing excess heat. The attached portion of thermally conductive top surface portion 356 may then spread the heat out to a larger area and volume thereby starting the dissipation process. It should be noted that the area of the individual bonding pad (area of continuous thermally conductive top bonding surface used for attachment) may be made significantly larger than the bonded footprint of heat generating electrical component 362. It should also be noted that trapezoidal protrusions 366 extending outwardly from upper copper clad portion 368 may be present in areas not used for bonding in order to more efficiently dissipate heat. Separation area 370 is also shown. Separation area 370 represents an area of discontinuity in thermally conductive top surface 356 and electrically isolates the thermally conductive bonding portion of top surface 356 attached to heat generating electrical component 352 from other areas of the board. In this respect, top bonding surface 356 may be etched into a pattern for both bonding and connecting the leads of electrical components as is done with traditional printed circuit boards. Component lead 372 is shown soldered to lead contact portion 374 of thermally conductive bonding top surface 356. Solder 364 can be made to flow into the spaces between trapezoidal protrusions 366 to form a zone having a high degree of electrical conductivity and thermal conductivity. Thermally conductive bottom bonding surface 360 may be used to fixedly attach bonded construction 350 to a rigid heat sink or other suitable heat dissipating substrate.

Good heat transfer characteristics of bonding substrate 354 may be realized by paying close attention to materials and their configuration. For example, copper is a good material choice for both thermally conductive bonding surfaces. Thin film FR-4 laminate of about 0.005″ in thickness has minimal thickness and therefore adds only minimal thermal resistance. Such material is available from Injectorall Electronics Corp located at 110 Keyland Court, Bohemia, N.Y. 11716. thin film FR-4 material is available in 0.005″ thickness with 0.5 ounce copper cladding on both sides. Electroplating copper onto this cladding to a thickness of 0.005″ on both sides followed by electroforming copper protrusions from about 0.005″ to 0.010″ in height would result in useable substrates for numerous applications. The exact configurations employed may of course depend on the particular applications employed.

The finished thermally conductive bonding laminate material may then be laminated with a thick photo-resist material, and subsequently exposed through a master, developed, and etched. Once etched, the board may then be stripped of undeveloped photo-resist and thoroughly cleaned. Electrical components may then be bonded into place and later soldered. The flexible circuit board may now be bonded on the back side to a rigid heat sink. By soldering component leads to their etched pads prior to bonding the construction to a heat sink, soldering may be made easier. Attempting to solder component leads to etched pads after heat sink bonding has taken place may require large inputs of heat energy in order to achieve good melting and subsequent wet out of solder.

FIG. 27 shows a bonding substrate of the present invention having numerous protrusions extending outwardly from the surface. Bonding substrate 376 is shown having trapezoidal protrusions 378 extending in an outward direction from top surface 380 of base portion 382.

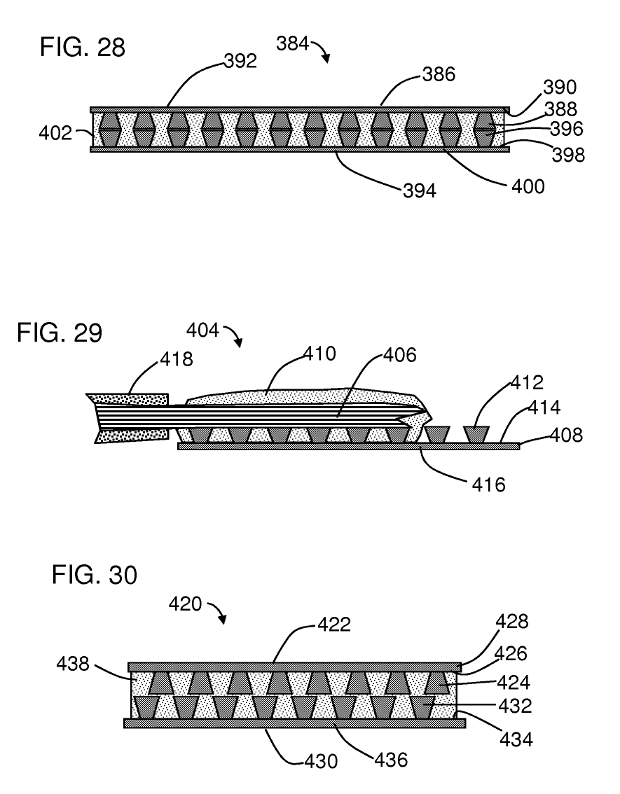

FIG. 28 shows a cross sectional view of a bonded construction of the present invention having a high degree of thermal conductivity. Laminated and bonded construction 384 is shown having a top bonding substrate 386 comprised of numerous trapezoidal protrusions 388 extending from surface 390 of top portion 392. Also shown is bottom bonding substrate 394 comprised of numerous trapezoidal protrusions 396 extending from surface 398 of bottom portion 400. Thermally conductive bonding agent 402 is also shown. Thermally conductive bonding agent 402 is shown forming a thermally conductive interlocking bond to both top bonding substrate 386 and bottom bonding substrate 394.

Thermally conductive bonding agent 402 may be comprised of a mixture of a liquid bonding agent such as epoxy blended with a material that enhances thermal conductivity. For example liquid epoxy bonding agents may be blended with powdered copper to enhance thermal conductivity. Copper powder prepared by the interaction of mossy zinc with aqueous copper sulfate solutions may be used to provide good thermal conductive properties to composite circuit board materials.

FIG. 29 shows a cross sectional view of a bonded construction of the present invention having a high degree of electrical conductivity. Bonded construction 404 is shown consisting of a wire 406 electrically connected to copper bonding pad 408 using solder 410. Copper bonding pad 408 is comprised of trapezoidal protrusions 412 extending outwardly from exposed top surface portion 414 of lower base portion 416 of copper bonding pad 408. Also shown is insulation 418 that covers wire 406. Solder 410 bonds wire 406 to copper bonding pad 408 and forms a good electrical connection. Solder 410 is shown encapsulating wire 406 and is also shown in an interlocking bonding configuration with copper bonding pad 408. Copper bonding pad 408 serves the following functions:

1) Bonds wire 406 securely into place.

2) Provides a good electrical connection to wire 406.

3) Provides an electrical connection capable of handling high current values.

4) Provides an electrical connection capable of dissipating substantial amounts of heat.

5) Improves the overall quality of soldered connections by increasing the available interfacial surface area between the circuit board and solder.

FIG. 30 shows a cross sectional view of a bonded construction of the present invention having a high degree of magnetic permeability. Laminated and bonded construction 420 is shown having a top bonding substrate 422 comprised of numerous trapezoidal protrusions 424 extending from surface 426 of top portion 428. Also shown is bottom bonding substrate 430 comprised of numerous trapezoidal protrusions 432 extending from surface 434 of bottom portion 436. High magnetic permeability bonding agent 438 is also shown. High magnetic permeability bonding agent 438 is shown forming a magnetically conductive interlocking bond to both top bonding substrate 422 and bottom bonding substrate 430. Magnetic permeability across laminated bonded construction 420 depends on the ease of conduction of magnetic flux through the entire construction. High magnetic permeability may be achieved by minimizing the overall thickness of the bond, using materials of high magnetic permeability that may include magnetic materials such as iron for top bonding substrate 422 and bottom bonding substrate 430, and incorporating high magnetic permeability fillers into bonding agent 430. High magnetic permeability materials suitable for incorporation into bonding agent 438 include powdered iron and/or other powdered magnetic materials.

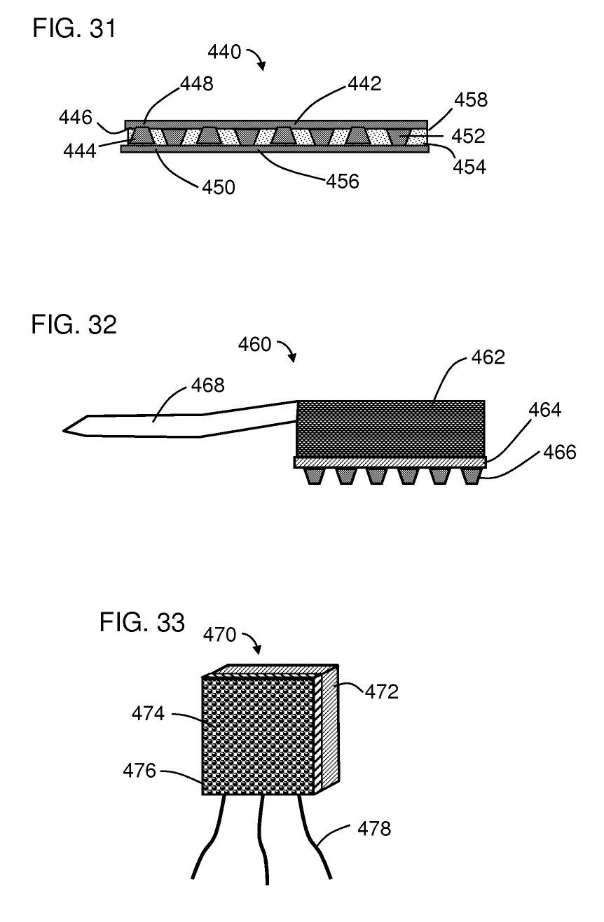

Laminated and bonded construction 420 may be employed in numerous applications including the bonding or permanent magnets. It should be noted that improved properties of magnetic permeability may be realized by reducing the overall thickness of the bonding zone by properly spacing and interposing trapezoidal protrusions 424 extending from surface 426 of top portion 428 with trapezoidal protrusions 432 extending from surface 434 of bottom portion 436. This particular configuration is shown in FIG. 31.

FIG. 31 shows a cross sectional view of a bonded construction of the present invention that interface with each other in an ultra-low profile configuration. Laminated and bonded construction 440 is shown having a top bonding substrate 442 comprised of numerous trapezoidal protrusions 444 extending from surface 446 of top portion 448. Also shown is bottom bonding substrate 450 comprised of numerous trapezoidal protrusions 452 extending from surface 454 of bottom portion 456. Thermally conductive bonding agent 458 is also shown. Thermally conductive bonding agent 458 is shown forming a thermally conductive interlocking bond to both top bonding substrate 442 and bottom bonding substrate 450. It should be noted that electrically conductive bonding agents may be used with electrically conductive top and bottom bonding substrates to provide electrical conductivity, thermally conductive bonding agents may be used with thermally conductive top and bottom substrates to provide thermal conductivity, and magnetic bonding agents may be used with magnetic top and bottom substrates to provide desirable magnetic properties.

The low profile geometry offered by bonded construction 440 may be desirable for use in bonding applications requiring exceptional thermal conductivity, and/or electrical conductivity, and/or magnetic permeability.

It should be noted that the low profile thermally conductive bonding surfaces of the present invention provide a means for surface mounting individual circuit components otherwise unfit for surface mounting. This may be advantageous in that it provides a greater choice of circuit components that may be surface mounted in particular while at the same time providing a means for removing excess heat.

FIGS. 32 and 33 outline the aspect of providing thermally conductive low profile bonding surfaces to circuit components to improve their overall bonding properties. It should be noted that it is often the case that individual circuit components have shapes that may facilitate interlocking properties with bonding agents. Despite this fact, there may be times when it is desirable to further enhance bonding properties of the individual circuit components by providing thermally conductive low profile bonding surfaces of the present invention.

FIG. 32 shows a cross sectional view of a circuit component of the present invention having a heat dissipating bonding zone attached. Circuit component 460 is shown having resin portion 462 along with heat dissipating metal portion 464 with attached low profile thermally conductive bonding protrusions 466. Also shown is lead 468.

FIG. 33 shows a circuit component of the present invention having a heat dissipating bonding zone attached. Circuit component 470 is shown having resin portion 472 along with heat dissipating metal portion 474 with attached low profile thermally conductive bonding protrusions 476. Also shown is leads 478.

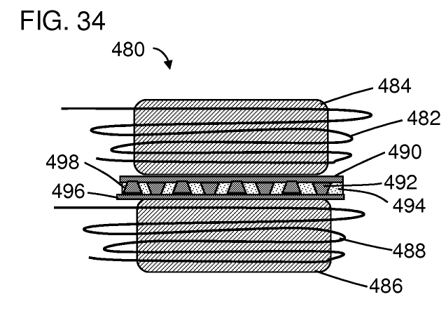

FIG. 34 shows a magnetic assembly of the present invention employing two electromagnets joined together to form a magnetic assembly. Electromagnet assembly 480 is shown having a first electromagnet winding 482 wrapped around a first iron core 484 forming a first electromagnet. Also shown is a second electromagnet winding 488 along with second iron core 486 forming a second electromagnet. Also shown is first iron layer 490 along with attached low profile iron bonding protrusions 492. Second iron layer 498 along with attached iron protrusions 498. High permeability bonding agent 494 completes the bonding layer. High permeability bonding agent 494 may comprise a resin based bonding agent loaded with a powdered material such as iron having a high magnetic permeability.

Those skilled in the art will understand that the preceding exemplary embodiments of the present invention provide foundation for numerous alternatives and modifications. These other modifications are also within the scope of the limiting technology of the present invention. Accordingly, the present invention is not limited to that precisely shown and described herein but only to that outlined in the appended claims.

What is claimed:

1. A low profile bonding construction for attaching an electrical component to a circuit board comprising:
a bonding pad on said circuit board, said bonding pad having a plurality of protrusions; and
a bonding agent, bonding said electrical component to said bonding pad wherein said plurality of protrusions have interlocking properties with said bonding agent.

2. The low profile bonding construction of claim 1 wherein said bonding pad is a thermally conductive bonding pad.

3. The low profile bonding construction of claim 2 wherein said bonding agent is thermally conductive.

4. The low profile bonding construction of claim 3 wherein said thermally conductive bonding agent is comprised of copper powder and epoxy resins.

5. The low profile bonding construction of claim 2 wherein said thermally conductive bonding pad is attached to fins.

6. The low profile bonding construction of claim 2 wherein said circuit board comprises of a top composite portion, a bottom composite portion, and a metal mesh portion.

7. The low profile bonding construction of claim 6 wherein said top composite portion contains thermally conductive additives.

8. The low profile bonding construction of claim 2 wherein said circuit board comprises of a top composite portion, a bottom composite portion, and an internal metal sheet.

9. The low profile bonding construction of claim 1 wherein said plurality of protrusions is hemispherical.

10. The low profile bonding construction of claim 1 wherein said plurality of protrusions is hour glass shaped.

11. The low profile bonding construction of claim 1 wherein said bonding pad is electrically conductive.

12. The low profile bonding construction of claim 2 further comprising of a soldering pad on said circuit board and a heat insulating zone underneath said soldering pad.

13. A bonding construction with a high level of magnetic permeability comprising:
a first bonding substrate with a plurality of protrusions;
a second bonding substrate with a plurality of protrusions; and
a high magnetic permeability bonding agent for bonding said first bonding substrate with said second bonding substrate, wherein a magnetically conductive interlocking bond is formed.

14. The bonding construction of claim 13 wherein said plurality of protrusions are trapezoidal.

15. The bonding construction of claim 13 wherein said first bonding substrate and said second bonding substrate are comprised of a magnetic material.

16. The bonding construction of claim 13 wherein said first bonding substrate is attached to a first electromagnet and said second bonding substrate is attached to a second electromagnet.

17. The bonding construction of claim 13 wherein said high magnetic permeability bonding agent is comprised of a high magnetic permeability filler.

18. The bonding construction of claim 17 wherein said high magnetic permeability filler is powdered iron.
